(19) United States
(12) Patent Application Publication
(10) Pub. No.: US 2012/0240592 A1
(43) Pub. Date: Sep. 27, 2012

(54) Combustor with Fuel Nozzle Liner Having Chevron Ribs

(75) Inventors: Mayur Abhay Keny, Bangalore (IN); Ronald Chila, Greenville, SC (US); Vaibhav Nadkarni, Bangalore (IN)

(73) Assignee: GENERAL ELECTRIC COMPANY, Schnectady, NY (US)

(21) Appl. No.: 13/069,424

(22) Filed: Mar. 23, 2011

(51) Int. Cl. F02C 7/22

(52) U.S. Cl. 60/776; 60/737; 60/746

(57) ABSTRACT

The present application and the resultant patent provide a fuel nozzle for mixing a flow of air and a flow of fuel within a combustor. The fuel nozzle may have one or more air passages for the flow of air, one or more fuel pegs for the flow of fuel, and a liner in communication with the air passages and surrounding the fuel pegs. The liner may include a number of ribs thereon so as to promote mixing of the flow of air and the flow of fuel therein.

### TECHNICAL FIELD

The present application relates generally to gas turbine engines and other types of turbo-machinery and more particularly relates to a combustor for a gas turbine engine with a fuel nozzle having chevron like ribs therein so as to promote good fuel/air mixing.

### BACKGROUND OF THE INVENTION

In a gas turbine engine, operational efficiency generally increases as the temperature of the combustion stream increases. Higher combustion stream temperatures, however, may produce higher levels of nitrogen oxides (“NOₓ”) and other types of emissions. Such emissions may be subject to both federal and state regulation in the United States and also subject to similar regulations abroad. A balancing act thus exists between operating the gas turbine engine in an efficient temperature range while also ensuring that the output of NOₓ and other types of regulated emissions remain below mandated levels.

Several types of known gas turbine engine designs, such as those using Dry Low NOₓ (“DLN”) combustors, generally premix the fuel flows and the air flows upstream of a reaction or a combustion zone so as to reduce NOₓ emissions via a number of premixing fuel nozzles. Such premixing tends to reduce overall combustion temperatures and, hence, NOₓ emissions and the like.

Premixing, however, also may present several operational issues such as flame holding, flashback, auto-ignition, and the like. These issues may be a particular concern with the use of highly reactive fuels. For example, a flame may be present in the head-end of a combustor upstream of the fuel nozzles with any significant fraction of hydrogen or other types of fuels. Any type of fuel enriched pocket thus may sustain a flame and cause damage to the combustor and related components or at least reduce the lifetime thereof.

There is thus a desire therefore for an improved combustor design with improved fuel/air mixing so as to avoid these known operational issues while continuing to limit undesirable emissions. Such a combustor design preferably can accommodate different types of fuels in a safe and efficient manner.

### SUMMARY OF THE INVENTION

The present application and the resultant patent thus provide a fuel nozzle for mixing a flow of air and a flow of fuel within a combustor. The fuel nozzle may have one or more air passages for the flow of air, one or more fuel pegs for the flow of fuel, and a liner in communication with the air passages and surrounding the fuel pegs. The liner may include a number of ribs thereon so as to promote mixing of the flow of air and the flow of fuel therein.

The present application and the resultant patent further provide a method of premixing a flow of air and a flow of fuel in a fuel nozzle. The method may include the steps of passing the flow of air through one or more air passages into a premixing area, passing the flow of fuel through one or more fuel passages into the premixing area, positioning a plurality of ribs in the premixing area, creating turbulence in the flow of air and the flow of fuel along the plurality of ribs, and mixing the flow of air and the flow of fuel.

The present application and the resultant patent further provide a combustor for mixing a flow of air and a flow of fuel. The combustor may include a number of primary fuel nozzles and a secondary fuel nozzle. The secondary fuel nozzle may include one or more air passages for the flow of air, one or more fuel pegs for the flow of fuel, and a liner. The liner may include a number of ribs thereon so as to promote mixing of the flow of air and the flow of fuel therein.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a known gas turbine engine.

FIG. 2 is a cross-sectional view of a Dry Low NOₓ combustor.

FIG. 3 is a cross-sectional view of a secondary fuel nozzle of a combustor as may be described herein.

FIG. 4 is a partial perspective view of the secondary fuel nozzle of FIG. 3 with the liner shown in phantom lines.

FIG. 5 is a perspective view of the chevron ribs as used in the secondary fuel nozzle of FIG. 3.

FIG. 6 is a perspective view of a swozzle vane as may be used herein as a fuel peg.

### DETAILED DESCRIPTION

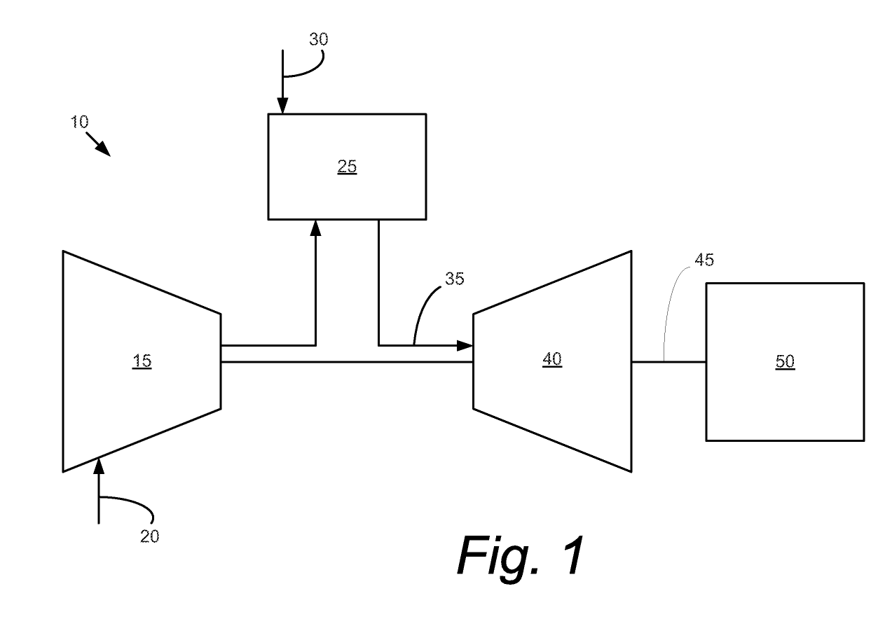

Referring now to the drawings, in which like numerals refer to like elements throughout the several views, FIG. 1 shows a schematic view of gas turbine engine 10 as may be used herein. The gas turbine engine 10 may include a compressor 15. The compressor 15 compresses an incoming flow of air 20. The compressor delivers the compressed flow of air 20 to a combustor 25. The combustor 25 mixes the compressed flow of air 20 with a compressed flow of fuel 30 and ignites the mixture to create a flow of combustion gases 35. Although only a single combustor 25 is shown, the gas turbine engine 10 may include any number of combustors 25. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, various types of syngas, and/or other types of fuels. The gas turbine engine 10 may be anyone of a number of different gas turbine engines offered by General Electric Company of Schenectady, N.Y., including, but not limited to, those such as a heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

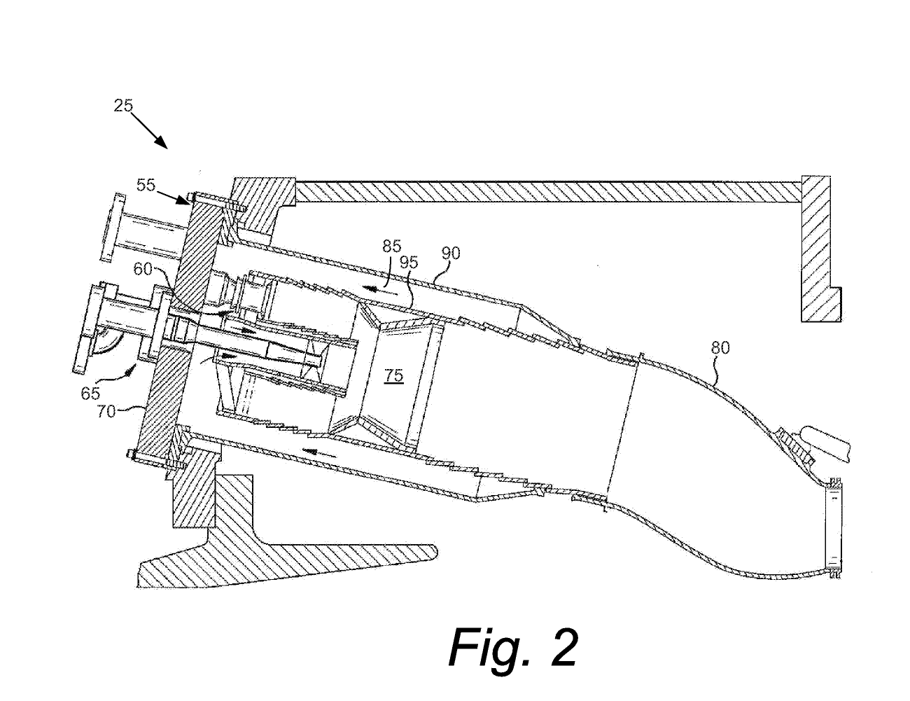

FIG. 2 shows one example of a combustor 25 that may be used herein. In this example, a Dry Low NOₓ combustor 55 may be used. Generally described, the Dry Low NOₓ combustor 55 may include a number of primary nozzles 60 surrounding a center secondary nozzle 65. The primary nozzles 60 and the secondary nozzle 65 may be positioned within an end cap 70 and face towards a downstream combustion zone 75. The combustion zone 75 extends into a transition piece 80 just upstream of the turbine 40. Air from the compressor 15 may enter through a flow path 85 extending between a flow sleeve 90 and a liner 95 before entering the fuel nozzles 60, 65 for combustion in the combustion zone 75 as described above. Other configurations and other components may be used herein.

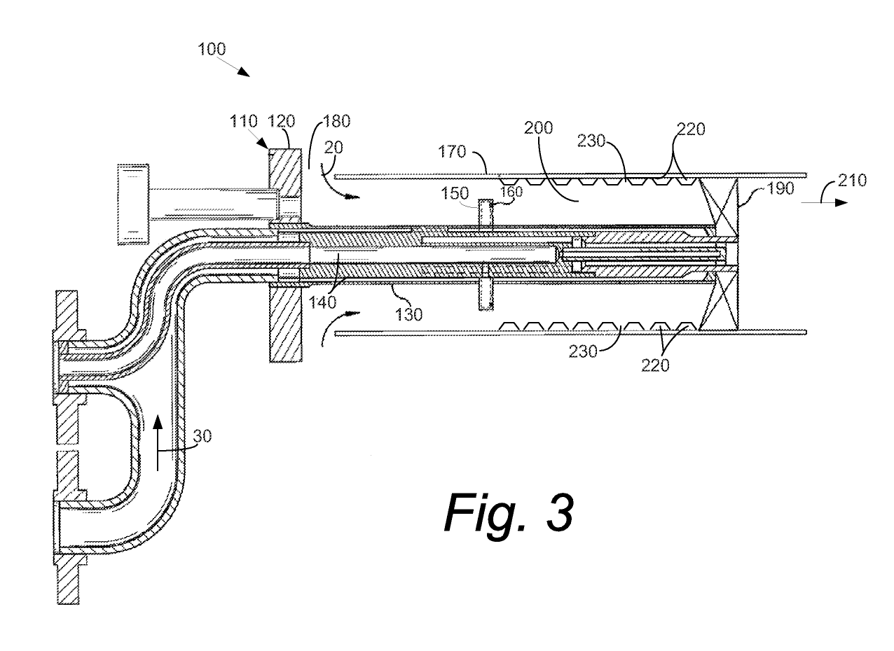

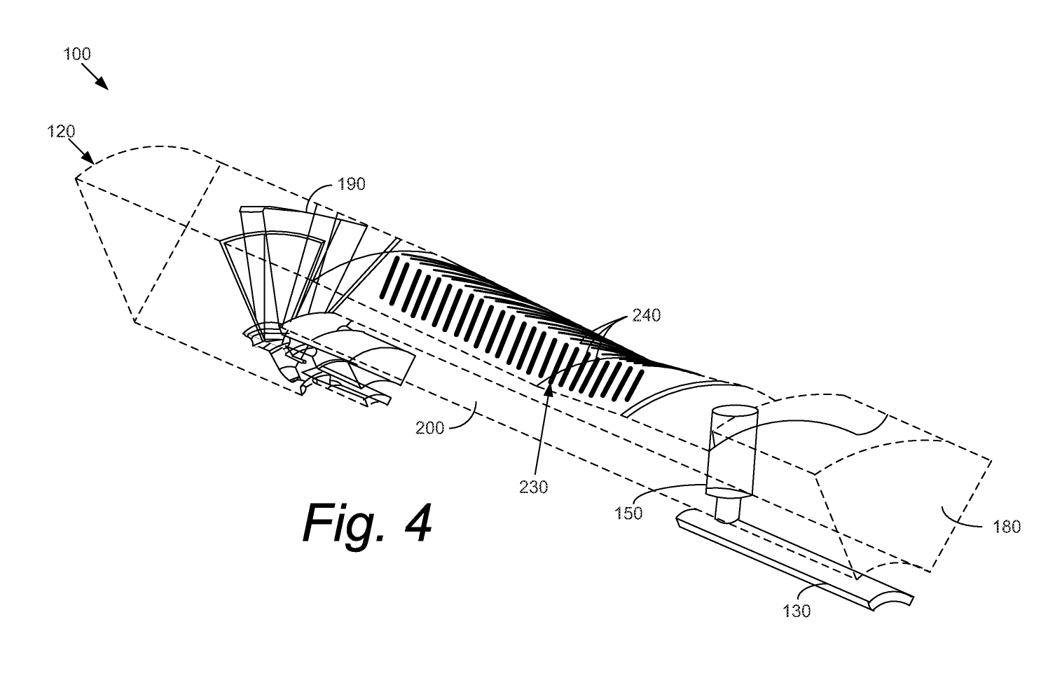

FIGS. 3 and 4 show a portion of a combustor 100 as may be described herein. As described above, the combustor 100 may include one or more fuel nozzles 110. In this example, a secondary fuel nozzle 120 is shown. Other types of fuel nozzles also may be used herein. Generally described, the secondary fuel nozzle 120 includes a gas body 130 extending through the end cap 70. The gas body 130 has a number of internal pathways 140 in communication with the flows of air 20 and the flows of fuel 30. One or more of the internal pathways 140 may lead to a number of fuel pegs 150. The fuel pegs 150 include a number of apertures or orifices 160 to allow a portion of the flows of fuel 30 to pass therethrough.

The secondary fuel nozzle 120 also includes a liner 170 surrounding the gas body 130. The liner 170 may extend from one or more axial air passages 180 at an upstream end to a swirler 190 at a downstream end. The axial air passages 180 may be in communication with the flow of air 20 from the compressor 15 as described above or otherwise. The liner 170 and the gas body 130 may define a premixing area 200 therebetween. The premixing area 200 allows the flow of air 20 from the axial air passages 180 to mix with the flow of fuel 30 from the fuel pegs 150 as a mixed flow 210 therein. The mixed flow 210 then may be swirled within the swirler 190 to promote further mixing. The mixed flow 210 then may be ignited in the combustion zone 75 downstream of the combustor 100. Other components and other configurations may be used herein.

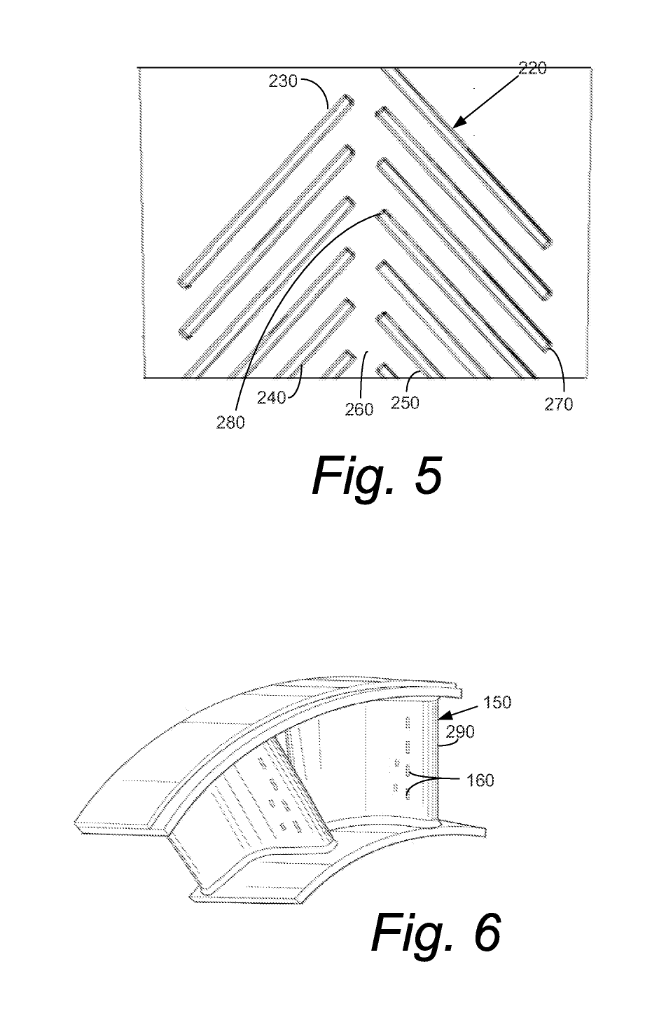

The combustor 100 may include a number of ribs 220 positioned in the liner 170. The ribs 220 may be positioned about the premixing area 200 between the fuel pegs 150 and the swirler 190. The ribs 220 may extend into the premixing area 200. The ribs 220 may be positioned in a chevron like pattern 230. As is shown in FIG. 5, the chevron like pattern 230 may include a first angled column 240 and an opposite second angled column 250. The first angled column 240 and the second angled column 250 may have an offset 260 therebetween. The columns 240, 250 thus are offset in the axial direction. The columns 240, 250 may be angled with respect to the direction of the flows 20, 30. The number of ribs 220 in each column 240, 250 may vary. The angle of the ribs 220 with respect to the direction of the flows 20, 30 may vary. The spacing and height of each rib 220 may vary. Although the ribs 220 are shown being substantially straight, the ribs 220 also may take a curved shape or any other desired shape. Multiple columns 240, 250 may be used in circumferential and/or axial directions.

The position of the ribs 220 in the chevron like pattern 230 ensures that one end of the ribs 220 acts as a leading edge 270 and the other edge acts as a trailing edge 280. Upon hitting the leading edge 270, a portion of the flows may be directed between the ribs 220. This flow between the ribs 220 meets a further flow coming from the opposite end so as to form a small recirculation zone. The recirculation zone forces the flows to extend radially away from the surface with the ribs 220 in the chevron like pattern 230. The radial flow makes the main flow divert circumferentially and enter the passage between the ribs 220 from the leading edge 270. This flow thus further increases the radial motion and ensures that the flows are constantly being radially displaced. This sequence sets up a radial motion in the overall flow field. As such, uniform mixing of the flows 20, 30 may be provided. The amount of radial motion and, hence, the amount of mixing may be varied by the design and the configuration of the ribs 220 and the chevron like pattern 230.

The use of the ribs 220 and the chevron like pattern 230 thus helps create a radial flow field so as to mix the flow of air 20 and the flow of fuel 30 into the mixed flow 210. Improved fuel/air mixing helps to improve the fuel/air ratio and also provides a significantly uniform fuel/air profile. The ribs 220 and the chevron like pattern 230 may be varied for the desired fuel/air profile.

Improvements in the mixing of the flows of air 20 and the flows of fuel 30 should contribute to a reduction in overall emissions produced herein. Further, the positioning and configuration of the ribs 220 and the chevron like pattern 230 may vary and, hence, the fuel/air profile may vary so as to eliminate or reduce downstream hot spots. As such, the durability and lifetime of the downstream components may improve. The fuel/air mixing herein also may be increased without a significant pressure drop penalty.

Although the fuel nozzle 120 described herein has been explained in the context of a DLN 1+ combustor, any type of combustor with any type of fuel nozzle may be used herein. The DLN 1+ combustor is offered by General Electric Company of Schenectady, N.Y. The combustor used herein may be a DLN 1 combustor, a DLN 2 combustor, a DLN 2.6 combustor, a DLN 2+ combustor, and the like. In the example of a DLN 2 combustor and the like, the fuel pegs 150 may take the form of a swozzle vane 290. As is shown in FIG. 6, the apertures 160 extend along the length of the swozzle vane 290 for the flow of fuel 30 therethrough. The ribs 220 may be positioned downstream of the swozzle vanes 290 to promote good mixing as described above in the premixing area 200. Other types of combustor and fuel nozzles with other configurations and other components may be used herein.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A fuel nozzle for mixing a flow of air and a flow of fuel within a combustor, comprising:
one or more air passages for the flow of air;
one or more fuel pegs for the flow of fuel; and
a liner in communication with the one or more air passages and surrounding the one or more fuel pegs;
wherein the liner comprises a plurality of ribs thereon so as to promote mixing of the flow of air and the flow of fuel.

2. The fuel nozzle of claim 1, wherein the fuel nozzle comprises a secondary fuel nozzle.

3. The fuel nozzle of claim 1, further comprising a gas body with one or more internal pathways in communication with the one or more fuel pegs.

4. The fuel nozzle of claim 3, wherein the gas body and the liner define a premixing area therebetween.

5. The fuel nozzle of claim 4, wherein the plurality of ribs extends into the premixing area.

6. The fuel nozzle of claim 4, wherein the flow of air and the flow of fuel form a mixed flow in the premixing area.

7. The fuel nozzle of claim 1, further comprising a swirler positioned about the liner.

8. The fuel nozzle of claim 1, wherein the plurality of ribs comprises a chevron like pattern on the liner.

9. The fuel nozzle of claim 1, wherein the plurality of ribs comprises a first column of ribs, a second column of ribs, and an offset therebetween.

10. The fuel nozzle of claim 1, wherein the one or more fuel pegs comprise one or more swozzle vanes.

11. A method of premixing a flow of air and a flow of fuel in a fuel nozzle, comprising:
passing the flow of air through one or more air passages into a premixing area;
passing the flow of fuel through one or more fuel passages into the premixing area;
positioning a plurality of ribs in the premixing area;
creating turbulence in the flow of air and the flow of fuel along the plurality of ribs; and
mixing the flow of air and the flow of fuel.

12. The method of claim 11, wherein the step of positioning the plurality of ribs in the premixing area comprises positioning the plurality of ribs in a chevron like pattern.

13. The method of claim 11, wherein the step of positioning the plurality of ribs in the premixing area comprises positioning the plurality of ribs in a first column and a second column with an offset therebetween.

14. The method of claim 11, further comprising the step of creating a mixed flow of the flow of air and the flow of fuel.

15. The method of claim 14, further comprising the step of passing the mixed flow through a swirler.

16. A combustor for mixing a flow of air and a flow of fuel, comprising:
a plurality of primary fuel nozzles; and
a secondary fuel nozzle;
the secondary fuel nozzle comprises one or more air passages for the flow of air, one or more fuel passages for the flow of fuel, and a liner;
wherein the liner comprises a plurality of ribs thereon so as to promote mixing of the flow of air and the flow of fuel therein.

17. The combustor of claim 16, wherein the fuel body and the liner define a premixing area therebetween.

18. The combustor of claim 17, wherein the plurality of ribs extends into the premixing area.

19. The combustor of claim 16, wherein the plurality of ribs comprises a chevron like pattern on the liner.

20. The combustor of claim 16, wherein the plurality of ribs comprises a first column of ribs, a second column of ribs, and an offset therebetween.
